(19) United States
(12) Patent Application Publication
(10) Pub. No.: US 2010/0232065 A1
(43) Pub. Date: Sep. 16, 2010

(54) MAGNETIC DISK AND METHOD OF MANUFACTURING THE SAME

(75) Inventors: Kota Suzuki, Shinjuku-ku (JP); Koichi Shimokawa, Shinjuku-ku (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION, Shinjuku-ku, Tokyo (JP)

(21) Appl. No.: 12/295,621

(22) PCT Filed: Mar. 29, 2007
(86) PCT No.: PCT/JP2007/056772

§ 371 Date: Sep. 30, 2008

(30) Foreign Application Priority Data
Mar. 30, 2006 (JP) 2006-093012

(51) Int. Cl. G11B 5/82; G11B 5/84

(52) U.S. Cl. 360/135; 427/535; G9B/5.293

(57) ABSTRACT

A magnetic disc is provided with a magnetic layer, a protection layer and a lubrication layer in this order on a substrate. After successively forming the magnetic layer and the protection layer on the substrate, the protection layer is exposed to plasma under normal pressure, then, the lubrication layer is formed on the protection layer. The plasma is generated in at least one kind of gas selected from among nitrogen gas, argon gas, oxygen gas, and fluorine hydrocarbon gas. The protection layer is a hydrogenated carbon protection layer.

### TECHNICAL FIELD

This invention relates to a magnetic disk adapted to be mounted in a magnetic disk drive such as a hard disk drive and to a manufacturing method thereof.

### BACKGROUND ART

Conventionally, a magnetic disk adapted to be mounted in a magnetic disk drive such as a hard disk drive (HDD) is provided with a protective layer on a magnetic recording layer formed on a substrate and is further provided with a lubricating layer on the protective layer for the purpose of ensuring the durability and reliability of the magnetic disk.

In response to such a demand, conventionally, a carbon-based material has been used as a material of the protective layer and particularly diamond-like carbon (hereinafter abbreviated as “DLC”) has often been used because of its excellent durability. Normally, a protective layer made of DLC is formed by a sputtering method or a CVD method. The conventional DLC protective layer formed by such a method generally has a two-layer structure comprising a highly rigid hydrogenated (CH carbon) DLC layer containing hydrogen atoms and, as an upper layer thereon, a nitrogenated DLC layer containing nitrogen atoms and so on, which is less rigid than the hydrogenated DLC, in consideration of adhesion to a lubricating layer (see, e.g. Japanese Unexamined Patent Application Publication (JP-A) No. 2003-248917 [Patent Document 1] and Japanese Patent (JP-B) No. 3058066 [Patent Document 2]). A lubricating layer is provided on such a protective layer. The lubricating layer used at the outermost surface is required to have various properties such as long-term stability, chemical substance resistance, friction property, and anti-heat property.

In the mean time, as demands required for a protective layer and a lubricating layer of a future magnetic disk, since the mechanical spacing between a magnetic head and a magnetic recording layer of a magnetic disk is required to be further reduced in terms of a demand for rapid improvement in information recording density of magnetic disks in recent years, there is firstly a reduction in thickness of the protective layer and the lubricating layer that are present in that spacing. Secondly, the protective layer is required to have high rigidity so that it can endure further reduction in thickness.
Patent Document 1: Japanese Unexamined Patent Application Publication (JP-A) No. 2003-248917
Patent Document 2: Japanese Patent (JP-B) No. 3058066

### DISCLOSURE OF THE INVENTION

### Problem to be Solved by the Invention

In recent years, magnetic disk drives such as an HDD have been rapidly increasing the storage capacities thereof. Recently, LUL (Load Unload)-system magnetic disk drives are being introduced in place of conventional CSS (Contact Start and Stop)-system ones. In the LUL system, a magnetic head is retreated to an inclined platform called a ramp located outside a magnetic disk while the drive is stopped, then at the time of start-up, the magnetic head is caused to slide from the ramp, after the magnetic disk starts to rotate, so as to fly over the magnetic disk to perform recording/reproduction. The LUL system is preferable for increasing the information capacity because, as compared with the CSS system, a wider recording/reproducing region can be ensured on the surface of the magnetic disk. Further, inasmuch as it is not necessary to provide a convex-concave shape for CSS on the surface of the magnetic disk, it is possible to significantly smooth the surface of the magnetic disk. Consequently, the flying height of the magnetic head can be much reduced and therefore it is possible to increase the S/N ratio of a recording signal, which is thus preferable.

Because of the significant reduction in magnetic head flying height following the introduction of the LUL system, it has become required that a magnetic disk stably operates even in the case of an ultra-low flying height of 10 nm or less. Recently, in order to increase the response speed of a magnetic disk drive, the rotation speed of a magnetic disk is increased. The rotation speed of a small-diameter 2.5-inch magnetic disk drive suitable for mobile applications was conventionally about 4200 rpm, while, recently, the response characteristics thereof are enhanced by rotating it at a high speed of 5400 rpm or more. Further, magnetic disk drives have recently been used not only as a storage apparatus of a conventional personal computer, but also as that of, for example, a car navigation system and, therefore, the environment resistance required for magnetic disks has become very strict due to diversification of applications of use and so on.

In the mean time, inasmuch as a protective layer and a lubricating layer provided at the surface of a magnetic disk are present between a magnetic head and a magnetic recording layer of the magnetic disk, further reduction in thickness of those layers is required in terms of further reduction in mechanical spacing between the magnetic head and the magnetic recording layer of the magnetic disk. Particularly, the protective layer is required to have rigidity and stability that can support the long-term reliability even if the thickness thereof is reduced, and is further required to have affinity to a lubricant forming the lubricating layer. As also described before, a protective layer made of DLC is normally formed by the sputtering method or the CVD method and the conventional DLC protective layer formed by such a method generally has a two-layer structure comprising a hydrogenated DLC layer and, as an upper layer thereon, a nitrogenated DLC layer. The hydrogenated DLC layer has a feature in that it is composed of carbon atoms and hydrogen atoms and exhibits high mechanical strength, but it is poor in affinity to a perfluoropolyether-based lubricant generally used conventionally. On the other hand, the nitrogenated DLC layer has a feature in that it is composed of carbon atoms, hydrogen atoms, and, further, nitrogen atoms and, although its mechanical strength is less than that of the hydrogenated DLC layer, it has high affinity to the perfluoropolyether-based lubricant and thus tends to facilitate formation of an excellent lubricant film.

However, there has been a problem that when the hydrogenated DLC layer is first formed and then the nitrogenated DLC layer is formed thereon using the conventional CVD method, the nitrogenation proceeds to the lower-layer hydrogenated DLC layer to reduce the mechanical strength of the protective layer and, therefore, in order to ensure the certain mechanical strength required for the protective layer, there is no alternative but to first increase the thickness of the hydrogenated DLC layer, and thus it is difficult to reduce the thickness of the whole protective layer. This has been an impeding factor for realizing a magnetic disk that can achieve further reduction in mechanical spacing between a magnetic head and a magnetic recording layer of the magnetic disk in terms of improving the information recording density.

In view of this, there has been required a magnetic disk protective layer having high mechanical strength and yet having high affinity to a lubricating layer in order to realize further reduction in thickness of the protective layer.

It is therefore an object of this invention to provide a magnetic disk comprising a protective layer having high mechanical strength that can endure further reduction in thickness, and having high affinity to a lubricating layer, and a method of manufacturing such a magnetic disk.

It is another object of this invention to provide a magnetic disk having a highly durable protective layer and excellent in long-term reliability and a method of manufacturing such a magnetic disk.

### Means for Solving the Problem

The present inventors have found that the above objects can be achieved by the following inventions, and have completed this invention.

Specifically, this invention has each of the following structures.

(Structure 1) A magnetic disk manufacturing method is of manufacturing a magnetic disk having a magnetic layer, a protective layer, and a lubricating layer in this order over a substrate. The method comprises forming the magnetic layer and the protective layer in this order over the substrate, then exposing the protective layer to a plasma under normal pressure, and thereafter forming the lubricating layer on the protective layer.

(Structure 2) A magnetic disk manufacturing method according to Structure 1, wherein the plasma is a plasma generated in at least one kind of gas selected from a nitrogen gas, an argon gas, an oxygen gas, and a fluorine-based hydrocarbon gas.

(Structure 3) A magnetic disk manufacturing method according to Structure 1 or 2, wherein the protective layer is a hydrogenated carbon-based protective layer.

(Structure 4) A magnetic disk having a magnetic layer, a protective layer, and a lubricating layer in this order over a substrate, wherein the protective layer is subjected to a treatment of exposure to a plasma under normal pressure before forming the lubricating layer on the protective layer.

(Structure 5) A magnetic disk according to Structure 4, wherein a treated layer is formed at a surface of the protective layer according to a kind of atmospheric gas used for generating said plasma.

(Structure 6) A magnetic disk according to Structure 4 or 5, wherein the protective layer is a hydrogenated carbon-based protective layer.

(Structure 7) A magnetic disk according to any one of Structures 4 to 6, wherein the protective layer has a thickness of 0.5 to 3.0 nm.

### EFFECT OF THE INVENTION

According to the invention having Structure 1, there is provided a method of manufacturing a magnetic disk having a magnetic layer, a protective layer, and a lubricating layer in this order over a substrate, wherein, by forming the magnetic layer and the protective layer in this order over the substrate and then by exposing the protective layer to a plasma under normal pressure, it is possible to improve the affinity of the protective layer to the lubricating layer so that the lubricating layer with good adhesion can be formed on the protective layer without positively providing a nitrogenated DLC layer with low mechanical strength as conventionally. Using the plasma treatment under normal pressure, it is possible to further reduce the thickness of the protective layer than conventional because it is not necessary to positively provide the nitrogenated DLC layer as conventionally and because, inasmuch as the treatment of only the very outermost surface of the protective layer is enabled, a reduction in mechanical strength of the protective layer is small. Therefore, it is also possible to respond to the demand for further reduction in mechanical spacing between a magnetic head and a recording layer in recent years.

Further, according to the invention having Structure 2, in the invention having Structure 1, the plasma used in the plasma treatment is a plasma generated in at least one kind of gas selected from a nitrogen gas, an argon gas, an oxygen gas, and a fluorine-based hydrocarbon gas. Therefore, it is possible to favorably change the properties of the surface of the protective layer so as to improve its affinity to the lubricating layer.

Further, as in the invention having Structure 3, when the protective layer is a hydrogenated carbon-based protective layer, the effect by the invention having Structure 1 or 2 is better achieved. That is, without reducing the mechanical strength of the hydrogenated carbon-based protective layer that has high mechanical strength but is poor in affinity to the lubricating layer, it is possible to improve the affinity thereof to the lubricating layer.

Further, according to the invention having Structure 4, there is provided a magnetic disk having a magnetic layer, a protective layer, and a lubricating layer in this order over a substrate, wherein the protective layer is subjected to a treatment of exposure to a plasma under normal pressure before forming the lubricating layer on the protective layer. Therefore, it is possible to improve the affinity of the protective layer to the lubricating layer so that the lubricating layer with good adhesion can be provided on the protective layer without positively providing a nitrogenated DLC layer with low mechanical strength as conventionally. Using the plasma treatment under normal pressure, it is possible to further reduce the thickness of the protective layer than conventional because it is not necessary to positively provide the nitrogenated DLC layer as conventionally and because, inasmuch as the treatment of only the very outermost surface of the protective layer is enabled, a reduction in mechanical strength of the protective layer is small. Therefore, it is also possible to respond to the demand for further reduction in mechanical spacing between a magnetic head and a recording layer in recent years.

Further, according to the invention having Structure 5, in the invention having Structure 4, a treated layer is formed at a surface of the protective layer according to a kind of atmospheric gas used for generating the plasma. Therefore, the surface of the protective layer is favorably changed in properties so as to be improved in affinity to the lubricating layer.

Further, as in the invention having Structure 6, when the protective layer is a hydrogenated carbon-based protective layer, the effect by the invention having Structure 4 or 5 is better achieved. That is, without reducing the mechanical strength of the hydrogenated carbon-based protective layer that has high mechanical strength but is poor in affinity to the lubricating layer, it is possible to improve the affinity thereof to the lubricating layer.

Further, as in the invention having Structure 7, the thickness of the protective layer can be set to 0.5 to 3.0 nm, i.e. thinner than conventional.

### BRIEF DESCRIPTION OF THE DRAWINGS

FIG. 1 is an exemplary sectional view of a magnetic disk according to Example 1 of this invention.

FIG. 2 is a diagram showing the relationship between the plasma treatment time (substrate processing time) and the lubricating layer thickness with respect to the magnetic disk of FIG. 1.

FIG. 3 is a diagram showing the relationship between the plasma treatment time (substrate processing time) and the lubricating layer thickness with respect to a magnetic disk of Reference Example 2.

### BEST MODE FOR CARRYING OUT THE INVENTION

Hereinbelow, this invention will be described in detail in terms of an embodiment.

A magnetic disk according to the embodiment of this invention is a magnetic disk having a magnetic layer, a protective layer, and a lubricating layer in this order on a substrate, wherein the protective layer is subjected to a treatment of exposure to a plasma under normal pressure (hereinafter, this treatment may be referred to as a “normal pressure plasma treatment” or simply as a “plasma treatment”) before forming the lubricating layer on the protective layer. By applying the normal pressure plasma treatment to the protective layer before forming the lubricating layer on the protective layer, it is possible to improve the affinity of the protective layer to the lubricating layer (particularly a perfluoropolyether-based lubricating layer). Therefore, the lubricating layer with good adhesion can be provided on the protective layer without positively providing a nitrogenated DLC layer with low mechanical strength as conventionally.

The magnetic disk described above is obtained by forming the magnetic layer and the protective layer in this order on the substrate, then applying the normal pressure plasma treatment to the protective layer, and then forming the lubricating layer on the protective layer.

The normal pressure plasma treatment is carried out by generating a high-frequency plasma under normal pressure in a single gas such as, for example, a nitrogen gas, an argon gas, an oxygen gas, and a fluorine-based hydrocarbon gas or in a mixed gas appropriately combining them and by exposing the protective layer to the plasma before the formation of the lubricating layer. In this case, only the protective layer of the magnetic disk having the protective layer at the surface thereof may be exposed to the plasma or the entire magnetic disk may be exposed to the plasma in the state where the protective layer is sufficiently exposed to the plasma. By applying this plasma treatment, it is possible to favorably change the properties of the surface of the protective layer so as to improve its affinity to the lubricating layer. By prolonging the plasma treatment time, the adhesion of a lubricant is improved so that the lubricating layer is formed as conventionally even in a solution with a low concentration of the lubricant. Further, by performing the plasma treatment, even if immersed in a lubricant solution under the same conditions as in the case of no plasma treatment, a thicker lubricating layer is formed and thus it is possible to form the lubricating layer in a short time.

Further, by applying the above-mentioned plasma treatment to the protective layer, a treated layer is formed at the surface (very outermost surface) of the protective layer according to the kind of atmospheric gas used for generating the plasma. For example, if a carbon-based protective layer is exposed to a high-frequency nitrogen plasma generated in a nitrogen gas atmosphere, nitrogen radicals react with the carbon-based protective layer so that only a very surface layer of the protective layer is implanted with nitrogen so as to be nitrogenated. On the other hand, if a carbon-based protective layer is exposed to a high-frequency oxygen plasma generated in a mixed gas atmosphere of nitrogen and oxygen, oxygen radicals react with the carbon-based protective layer so that only a very surface layer of the protective layer is implanted with oxygen so as to be oxidized. By the formation of, for example, the nitrogenated layer or the oxidized layer at the surface (very surface layer) of the protective layer as described above, it is possible to favorably change the properties of the surface of the protective layer so as to improve its affinity to the lubricating layer. Further, for example, the oxygen plasma serves to oxidize organic-based contaminants present on the surface of the protective layer to thereby remove them as a carbon dioxide gas and thus also has the cleaning effect for the surface of the protective layer.

It is preferable that the protective layer be a carbon-based protective layer, particularly a hydrogenated carbon-based protective layer (e.g. a hydrogenated DLC layer). That is, although the hydrogenated carbon-based protective layer has high mechanical strength but is poor in affinity to the lubricating layer, inasmuch as the affinity to the lubricating layer can be improved without reducing that high mechanical strength of the hydrogenated carbon-based protective layer, the effect is better achieved.

Even in the case where the protective layer has a two-layer structure comprising a hydrogenated carbon-based protective layer (e.g. a hydrogenated DLC layer) and, as an upper layer thereon, a nitrogenated carbon-based protective layer (e.g. a nitrogenated DLC layer), a lubricating layer with better adhesion can be obtained by applying the normal pressure plasma treatment to such a protective layer before forming the lubricating layer as compared with the case where a lubricating layer is formed without applying this plasma treatment to the protective layer.

Using the normal pressure plasma treatment, it is possible to further reduce the thickness of the protective layer than conventional because it is not necessary to positively provide a nitrogenated DLC layer for adhesion to the lubricating layer as conventionally (or, even if a nitrogenated DLC layer is provided, it can be much thinner than conventional) and because, inasmuch as the treatment of only the very outermost surface of the protective layer is enabled, a reduction in mechanical strength of the protective layer is small. Therefore, it is also possible to respond to the demand for further reduction in mechanical spacing between a magnetic head and a recording layer in recent years.

In this magnetic disk, when the protective layer is a hydrogenated carbon-based protective layer (e.g. a hydrogenated DLC layer), the thickness of the protective layer can be set to, for example, 0.5 to 3.0 nm and preferably 1.0 to 3.0 nm, i.e. it can be thinner than conventional.

When a carbon-based layer is used as the protective layer, it can be formed by, for example, a conventionally known DC magnetron sputtering method, plasma CVD method, or FCA (Filtered Cathodic Arc) method.

Inasmuch as the normal pressure plasma treatment can be carried out after forming the magnetic layer and the protective layer in this order on the substrate, for example, using the above-mentioned film forming method, there is a great advantage in that a subsequent lubricant coating process can be carried out in online. Further, when the protective layer is, for example, a single hydrogenated carbon-based protective layer, there is an advantage in that it is possible to reduce one ultrahigh vacuum chamber as compared with the case where the protective layer is in the form of two layers, i.e. a hydrogenated carbon-based protective layer and a nitrogenated carbon-based protective layer.

The normal pressure plasma treatment is carried out after forming the magnetic layer and the protective layer in this order on the substrate and, then, the lubricating layer is formed. Generally, a perfluoropolyether-based lubricant is preferably used as a magnetic disk lubricant. When forming the lubricating layer using the magnetic disk lubricant, it can be formed by using a solution in which the lubricant is dispersed and dissolved in an appropriate solvent and coating the solution, for example, by a dipping method. As the solvent, use can be preferably made, for example, of a fluorine-based solvent (trade name Vertrel XF or the like manufactured by DuPont-Mitsui Fluorochemicals Co., Ltd.). A film forming method for the lubricating layer is, of course, not limited to the above-mentioned dipping method and use may be made of a film forming method such as a spin coating method, a spray method, or a vapor coating method.

For further improving the adhesion of the formed lubricating layer to the protective layer, the magnetic disk may be exposed to an atmosphere at 70° C. to 200° C. after the film formation.

The thickness of the lubricating layer is not particularly limited, but is preferably set in a range of, for example, 5 Å to 20 Å. If it is less than 5 Å, there is a case where the lubricating performance as the lubricating layer is lowered. If it exceeds 20 Å, there is a case where the fly stiction failure occurs and there is a case where the LUL durability is lowered.

In this magnetic disk, the substrate is preferably a glass substrate. The glass substrate is rigid and excellent in smoothness and thus is suitable for an increase in recording density. As the glass substrate, an aluminosilicate glass substrate, for example, is cited and, particularly, a chemically strengthened aluminosilicate glass substrate is preferable.

A texture shape (e.g. a circumferential texture) may be formed on the main surface of the glass substrate, for example, for increasing the magnetic anisotropy of the magnetic layer. For forming, for example, the circumferential texture, there can be cited a method of pressing a polishing tape of a suitable material on the main surface of the glass substrate and of relatively moving the glass substrate and the tape to each other, or the like.

The main surface of the substrate is preferably ultra-smooth with Rmax of 6 nm or less and Ra of 0.6 nm or less. Rmax and Ra herein referred to are based on the JIS B0601 standard.

This magnetic disk comprises at least the magnetic layer, the protective layer, and the lubricating layer on the substrate, wherein the above-mentioned magnetic layer is not particularly limited and may be a magnetic layer for an in-plane recording system or a magnetic layer for a perpendicular recording system. Particularly, if it is a CoPt-based magnetic layer, high coercive force and high reproduction output can be achieved, which is thus preferable.

In this magnetic disk, an underlayer may be provided between the substrate and the magnetic layer if necessary. Further, an adhesive layer, a soft magnetic layer, and so on may be provided between the underlayer and the substrate. In this case, as the underlayer, for example, a Cr layer, a Ta layer, a Ru layer, a CrMo, CoW, CrW, CrV, or CrTi alloy layer, or the like is cited and, as the adhesive layer, for example, a CrTi, NiAl, or AlRu alloy layer or the like is cited. Further, as the soft magnetic layer, for example, a CoZrTa alloy film or the like is cited.

This magnetic disk is particularly suitable as a magnetic disk adapted to be mounted in a load/unload-system magnetic disk drive.

Hereinbelow, this invention will be described in further detail using magnetic disks according to Examples.

### Example 1

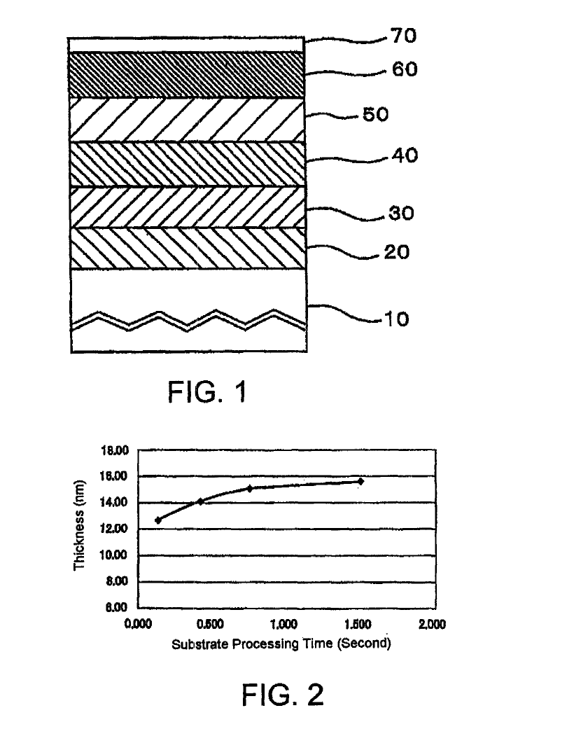

FIG. 1 illustrates a magnetic disk according to Example 1 of this invention.

The magnetic disk is fabricated by forming an adhesive layer 20, a soft magnetic layer 30, an underlayer 40, a perpendicular magnetic recording layer 50, a protective layer 60, and a lubricating layer 70 in this order on a substrate 10.

### (Manufacture of Magnetic Disk)

A 2.5-inch glass disk (outer diameter 65 mm, inner diameter 20 mm, disk thickness 0.635 mm) made of a chemically strengthened aluminosilicate glass was prepared as the disk substrate 10. The main surface of the disk substrate 1 was mirror-polished to Rmax of 4.8 nm and Ra of 0.43 nm.

On the disk substrate 10, the adhesive layer 20, the soft magnetic layer 30, the underlayer 40, and the perpendicular magnetic recording layer 50 were formed in this order in an Ar gas atmosphere by the DC magnetron sputtering method. As the adhesive layer 20, a CrTi alloy film (Cr:50 at %, Ti:50 at %) was formed to a thickness of 200 Å.

As the soft magnetic layer 30, a CoZrTa alloy film (Co:88 at %, Zr:5 at %, Ta:7 at %) was formed to a thickness of 500 Å.

The underlayer 40 was formed to a thickness of 300 Å by laminating Ta films and Ru films.

As the perpendicular magnetic recording layer 50, a CoCrPt alloy film (Co:62 at %, Cr:20 at %, Pt:18 at %) was formed to a thickness of 200 Å.

Subsequently, the protective layer 60 of hydrogenated DLC was formed to a thickness of 25 Å by the plasma CVD method.

Subsequently, using a plasma reactor, a magnetic disk formed with up to the protective layer 60 was exposed to a high-frequency nitrogen plasma, generated in a nitrogen atmosphere under normal pressure, for a predetermined time.

Subsequently, the lubricating layer 70 was formed in the following manner.

Using a lubricant with Mw of 3000 and a molecular weight dispersion of 1.08 obtained by carrying out, using a GPC method, molecular weight fractionation of FOMBLIN Z-DOL (trade name), being a perfluoropolyether-based lubricant, manufactured by Solvay Solexis, Inc., there was prepared a solution in which the obtained lubricant was dispersed and dissolved at a concentration of 0.02 wt % in Vertrel XF (trade name), being a fluorine-based solvent, manufactured by DuPont-Mitsui Fluorochemicals Co., Ltd. Using this solution as a coating solution, the above-mentioned plasma-treated magnetic disk was immersed therein and coated therewith by the dipping method, thereby forming the lubricating layer 70. After the film formation, the magnetic disk was heat-treated in a vacuum furnace at 130° C. for 90 minutes. The thickness of the lubricating layer 70 was measured by a Fourier transform infrared spectrophotometer (FTIR) and it was 15 Å.

FIG. 2 shows the relationship between the above plasma treatment time (the time of exposure to the nitrogen plasma) and the lubricating layer thickness. According to the results of FIG. 2, the lubricating layer thickness depends on the plasma treatment time. This is because it is considered that nitrogen radicals generated in the normal pressure plasma react with the hydrogenated DLC protective layer to nitrogenate a very surface layer of the protective layer and the nitrogenation largely depends on the plasma treatment time so that the surface of the protective layer is more nitrogenated as the treatment time increases and, as a result, the affinity to the lubricating layer is more enhanced. Incidentally, the contact angle of the surface of the protective layer with respect to water was measured immediately after the normal pressure plasma treatment and it was found that the contact angle was reduced as compared with that before the treatment. Also from this, it is seen that the surface state of the protective layer was changed by the normal pressure plasma treatment. In this manner, the magnetic disk of Example 1 was obtained.

Further, a magnetic disk was fabricated in the similar manner as in Example 1 except that a protective layer was in the form of a laminate of a hydrogenated DLC layer of 30 Å formed by the plasma CVD method and a nitrogenated DLC layer of 5 Å formed thereon by the plasma CVD method and a lubricating layer was formed on the protective layer without performing the normal pressure plasma treatment. The magnetic disk thus obtained will hereinafter be referred to as “Reference Example 1”.

Further, a magnetic disk was fabricated in the similar manner as in Example 1 except that a protective layer was in the form of a laminate of a hydrogenated DLC layer of 30 Å formed by the plasma CVD method and a nitrogenated DLC layer of 5 Å formed thereon by the plasma CVD method and a lubricating layer was formed on the protective layer after performing the normal pressure plasma treatment under the same conditions as in Example 1. The magnetic disk thus obtained will hereinafter be referred to as “Reference Example 2”.

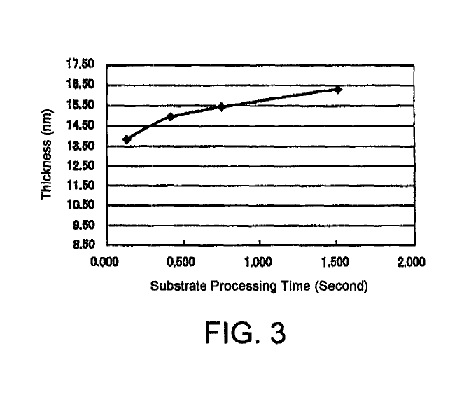

FIG. 3 shows the relationship between the plasma treatment time (the time of exposure to the nitrogen plasma) and the lubricating layer thickness with respect to the magnetic disk of Reference Example 2. Note that the magnetic disks of Reference Examples 1 and 2 were fabricated so that the lubricating layer thicknesses thereof approximately matched that of the magnetic disk of Example 1 by properly adjusting the lubricant coating conditions and the plasma treatment time (in the case of Reference Example 2).

Then, the obtained magnetic disks were evaluated according to the following test method.

### (Evaluation of Magnetic Disk)

A lubricating layer adhesion test was performed for evaluating the bonding performance (adhesion) of the lubricating layer with respect to the protective layer. At first, the thickness of the lubricating layer of the magnetic disk of Example 1 was measured by the FTIR method and it was 15 Å as described above. Subsequently, the magnetic disk of Example 1 was immersed in the fluorine-based solvent Vertrel XF for 1 minute. By the immersion in the solvent, lubricating layer portions with poor adhesion (fluidized lubricating layer) are dispersed and dissolved in the solvent, but lubricating layer portions with strong adhesion (fixed lubricating layer) can remain on the protective layer. Subsequently, the magnetic disk was removed from the solvent and the thickness of the lubricating layer was measured again by the FTIR method. The ratio of the thickness of the lubricating layer after the immersion in the solvent to the thickness of the lubricating layer before the immersion in the solvent is called a lubricating layer adhesion ratio (bonded ratio). It can be said that the higher the bonded ratio, the higher the bonding performance (adhesion) of the lubricating layer with respect to the protective layer. With the magnetic disk of Example 1, the bonded ratio was 85%. Inasmuch as the bonded ratio is judged to be preferable if it is 70% or more according to the conventional standard, it is seen that the magnetic disk of Example 1 is quite excellent in adhesion of the lubricating layer.

Further, the bonded ratio was also measured with respect to the magnetic disks of Reference Examples 1 and 2 in the similar manner. As a result, it was found that, while the bonded ratio of the magnetic disk of Reference Example 1 (Comparative Example) was 70%, the bonded ratio of Reference Example 2 where the structure of the protective layer was the same as in Reference Example 1, but the normal pressure plasma treatment was carried out before forming the lubricating layer was very high as high as 85% and thus the lubricating layer was excellent in adhesion.

This is considered to be caused by the fact that, by the normal pressure plasma treatment, the surface of the protective layer was changed in properties to increase its affinity to the lubricating layer or, in other words, the surface of the protective layer was activated so that the lubricant tends to be chemically bonded to the protective layer, and as a result, the ratio of the fixed lubricating layer was increased.

In summary, for example, as in Example 1, it is possible to manufacture a magnetic disk using only a hydrogenated DLC protective layer with high mechanical strength, it is possible to reduce the thickness of the protective layer than conventional, and further, it is possible to form on the protective layer a lubricating layer with a required thickness that is excellent in adhesion.

Then, an LUL (Load Unload) durability test was performed for examining the LUL durability of the obtained magnetic disk.

An LUL-system HDD (Hard Disk Drive) (5400 rpm rotation type) was prepared and a magnetic head with a flying height of 10 nm and the magnetic disk were mounted therein. A slider of the magnetic head is an NPAB slider and is mounted with a magnetoresistive effect element (GMR element) as a reproducing element. A shield portion is made of an FeNi-based permalloy alloy. By causing the LUL-system HDD to continuously repeat the LUL operations, the number of LUL times endured by the magnetic disk up to the occurrence of failure was measured.

As a result, the magnetic disk of Example 1 endured the LUL operations of 900,000 times with no failure at an ultra-low flying height of 10 nm. Inasmuch as a magnetic disk is judged to be preferable if it endures particularly 600,000 LUL times or more in a normal HDD using environment, it can be said that the magnetic disk of Example 1 has extremely high reliability. During the test, the fly stiction phenomenon did not occur. The surface of the magnetic disk and the surface of the magnetic head after the LUL durability test were observed in detail using an optical microscope and an electron microscope and were found to be excellent, i.e. no abnormality such as damage or dirt was observed and, further, no lubricant adhesion to the magnetic head or no corrosion failure was observed.

Further, an LUL durability test was also performed on the magnetic disks of Reference Examples 1 and 2 in the similar manner. As a result, the magnetic disk of Reference Example 1 (Comparative Example) failed when the number of LUL times reached 600,000 times, while, the magnetic disk of Reference Example 2 endured the LUL operations of 900,000 times with no failure.

### Example 2

A protective layer 60 of hydrogenated DLC was formed to a thickness of 25 Å on a magnetic recording layer 50 of Example 1 by the plasma CVD method, then, using a plasma reactor, a magnetic disk formed with up to the protective layer 60 was exposed to a high-frequency oxygen plasma, generated in a mixed gas atmosphere of nitrogen and oxygen (nitrogen:oxygen=99.7 vol:0.3 vol %) under normal pressure, for a predetermined time.

A magnetic disk of Example 2 was fabricated in the similar manner as in Example 1 except the above point. The thickness of a lubricating layer 70 was measured by a Fourier transform infrared spectrophotometer (FTIR) and it was 15 Å.

Also in Example 2, the lubricating layer thickness depends on the plasma treatment time. This is because it is considered that oxygen radicals generated in the normal pressure plasma react with the hydrogenated DLC protective layer to oxidize a very surface layer of the protective layer and the oxidation largely depends on the plasma treatment time so that the surface of the protective layer is more oxidized as the treatment time increases and, as a result, the affinity to the lubricating layer is more enhanced. Incidentally, the contact angle of the surface of the protective layer with respect to water was measured immediately after the oxygen plasma treatment and it was found that the contact angle was reduced as compared with that before the treatment. Also from this, it is seen that the surface state of the protective layer was changed by the oxygen plasma treatment.

Then, the obtained magnetic disk of Example 2 was evaluated.

At first, a lubricating layer adhesion test was performed in the similar manner as in Example 1 and, as a result, the bonded ratio was 85% with the magnetic disk of Example 2. According to Example 2, it is possible to manufacture a magnetic disk using only a hydrogenated DLC protective layer with high mechanical strength, it is possible to reduce the thickness of the protective layer than conventional, and further, it is possible to form on the protective layer a lubricating layer with a required thickness that is excellent in adhesion.

Further, an LUL durability test was performed and, as a result, the magnetic disk of Example 2 endured the LUL operations of 900,000 times with no failure at an ultra-low flying height of 10 nm. During the test, the fly stiction phenomenon did not occur. The surface of the magnetic disk and the surface of a magnetic head after the LUL durability test were observed in detail using an optical microscope and an electron microscope and were found to be excellent, i.e. no abnormality such as damage or dirt was observed and, further, no lubricant adhesion to the magnetic head or no corrosion failure was observed.

### INDUSTRIAL APPLICABILITY

A magnetic disk of this invention is suitable as a magnetic disk adapted to be mounted in a magnetic disk drive of a computer.

1. A magnetic disk manufacturing method of manufacturing a magnetic disk having a magnetic layer, a protective layer, and a lubricating layer in this order over a substrate, wherein said method comprising:
forming said magnetic layer and said protective layer in this order over said substrate;
exposing said protective layer to a plasma under normal pressure; and
forming said lubricating layer on said protective layer.

2. A magnetic disk manufacturing method according to claim 1, wherein said plasma is a plasma generated in at least one kind of gas selected from a nitrogen gas, an argon gas, an oxygen gas, and a fluorine-based hydrocarbon gas.

3. A magnetic disk manufacturing method according to claim 1, wherein said protective layer is a hydrogenated carbon-based protective layer.

4. A magnetic disk having a magnetic layer, a protective layer, and a lubricating layer in this order over a substrate, wherein said protective layer is subjected to a treatment of exposure to a plasma under normal pressure before forming said lubricating layer on said protective layer.

5. A magnetic disk according to claim 4, wherein a treated layer is formed at a surface of said protective layer according to a kind of atmospheric gas used for generating said plasma.

6. A magnetic disk according to claim 4, wherein said protective layer is a hydrogenated carbon-based protective layer.

7. A magnetic disk according to claim 4, wherein said protective layer has a thickness of 0.5 to 3.0 nm.
